(19) United States
(12) Patent Application Publication
(10) Pub. No.: US 2007/0002176 A1
(43) Pub. Date: Jan. 4, 2007

(54) Intelligent network interface module

(75) Inventors: Ernst Bressau, Singapore (SG); Johannes Petrus Martinus Teijssen, Geldrop (NL); Hendricus Martinus Van Der Wijst, Veldhoven (NL); Reiner Schulz, Dusseldorf (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/548,708

(22) PCT Filed: Mar. 2, 2004
(86) PCT No.: PCT/IB04/00618

§ 371 Date: Sep. 8, 2005

(30) Foreign Application Priority Data
Mar. 11, 2003 (EP) 03100603.4

(51) Int. Cl. H04N 3/27

(52) U.S. Cl. 348/554

(57) ABSTRACT

A description is given of a network interface module, a device and a method for receiving video data. The network interface module comprises functional units (12, 14, 16) for processing a high frequency signal and for supplying a digital video signal. A module microprocessor (24) and a memory (28) for an operating program are provided on the module. The module micro-processor (24) receives control commands via an interface (30) during running of the operating program and actuates the functional units (12, 14, 16) accordingly. The device for receiving video data has a dedicated control processor (38) which forwards control commands to the network interface module (10) via the interface (30).

The invention relates to a network interface module, a device and a method for receiving video data.

It is known how to transmit digital video data via various media in various standard formats or transmission methods. Among other things, the transmission of digital video data over cables (DVB-C), over satellite radio (DVB-S) and over terrestrial radio (DVB-T) are standardized. In each case, transmission takes place as a high frequency signal. The signal contains encoded digital video data as an MPEG-2 transport stream. The data moreover comprise an audio signal and additional data.

The devices provided to receive such video data may be, for example, set-top boxes, PC TV cards or television sets. The devices have a receiving part (HF receiver, frequency mixer, channel decoder, etc.), with these components being arranged either individually on the motherboard or on a network interface module (NIM). The corresponding functional units on the interface module are actuated by means of a device control processor, usually the main processor of the respective device. This actuation is hardware-specific, that is to say that the actuation must know the respective properties and capabilities of the ICs used on the module and actuate them accordingly.

U.S. Pat. No. 5,734,589 discloses a set-top box in respect of which it is proposed to design the NIM as a plug-in module. The module has an NIM controller which is to take over the “domestic” functions of the functional units. It is described that the replacement of an NIM requires modifications to the control software.

If, for example, the module design or application (e.g. DVB-C instead of DVB-T) is changed in such a device comprising a replaceable NIM module, then the control software has to be adapted. There is therefore a relatively high complexity when changing or replacing module variants. The appropriate control software for the respective device must be supplied with each module.

It is therefore an object of the invention to propose a network interface module, a video receiving unit and a method for receiving video data, in which both the actuation and the implementation of changes are particularly simple.

This object is achieved by a network interface module as claimed in claim 1, a device as claimed in claim 4 and a method as claimed in claim 9. Dependent claims relate to advantageous embodiments of the invention.

According to the invention, an NIM comprises a module microprocessor and a memory containing an operating program therefor. The module microprocessor receives control commands from outside the module via an interface. During running of the stored operating program, the microprocessor operates as an interpreter of these commands and converts the respective commands into actuation signals which are used to actuate the functional units.

The invention thus provides indirect actuation instead of the direct actuation of the functional units (receiving functional unit, channel decoder, etc.) that has been known to date, said direct actuation always requiring knowledge about the specific capabilities and properties of the components used in each case. It is thus possible for an NIM—independently of its specific design, that is to say for example regardless of which ICs specifically make up the functional units—always to be addressed with the same control commands. These control commands may thus be hardware-independent. The operating program of the microprocessor that is provided directly on the module contains information about the functional units and the actuation necessary in each case, said information making it possible for such preferred hardware-independent, function-related control commands to be converted into the control signals that are required in each case and are based on the specific type of functional unit that is present. The use of a bus system is preferred for the module-internal communication between the module microprocessor and the functional units.

The video receiving device according to the invention comprises at least one device control processor and at least one NIM. There may also be a number of NIMs. The NIM or NIMs may be replaceable within the module, for example may be connected by way of a plug-in connection. Modules for receiving various types of high frequency signal may be provided, for example DVB-S, DVB-T and DVB-C. Nevertheless, a number of modules of the same type may also be present. Furthermore, the device comprises functional units which are used to further process the digital video data stream supplied. The device may be, for example, a set-top box which supplies signals for outputting on a TV set, a PC TV plug-in card or even a TV set which itself displays the video data.

All configurations of this type can be realized very simply using an NIM according to the invention. A set of possible control commands is processed by the modules independently of which type of module is involved and which ICs are used to produce the functional units. These commands are thus hardware-independent.

When a number of slots for the plugging-in of modules are provided, it is preferred for the slots to have the same shape and the same assignment of plug contacts. This provides a mechanically and electrically universal interface.

When a module is plugged into a video receiving device, it is thus possible to carry out automatic configuration. The video receiving device may be prepared, for example, for various modules (for example different types of modules for different media, e.g. DVB-S, DVB-T, DVB-C modules). During automatic configuration, the module is recognized and the receiving device is configured accordingly.

The device recognizes which type of module is involved (e.g. DVB-S). This means that the device configuration is not determined until the NIM is plugged in. The advantage for the device manufacturer is that he requires fewer different motherboards for the range as a whole. Although control commands are hardware-independent, there may be differences between the various transmission methods in terms of the actuation for example. The device can be adjusted in this respect during automatic configuration, and the user menu can also be adapted accordingly.

The invention will be further described with reference to examples of embodiments shown in the drawings to which, however, the invention is not restricted.

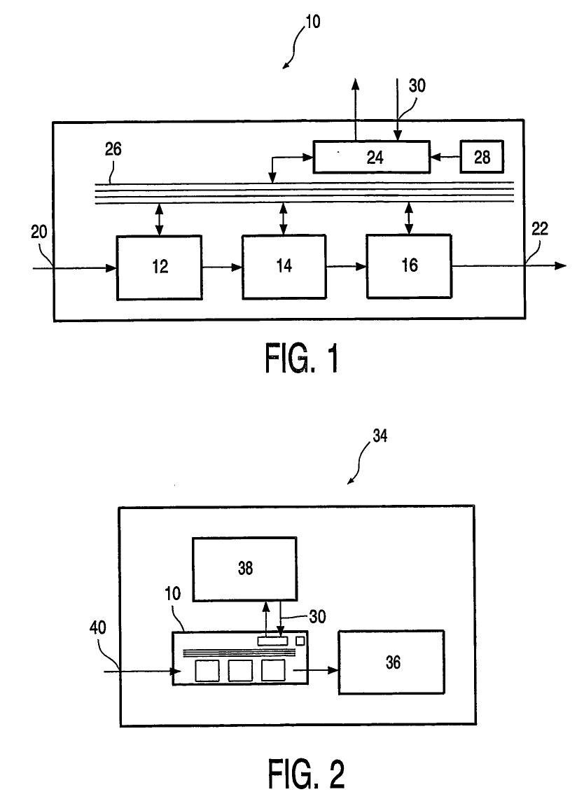

FIG. 1 shows a schematic diagram of a network interface module (NIM).

FIG. 2 shows a schematic diagram of a first embodiment of a video receiving device comprising a network interface module.

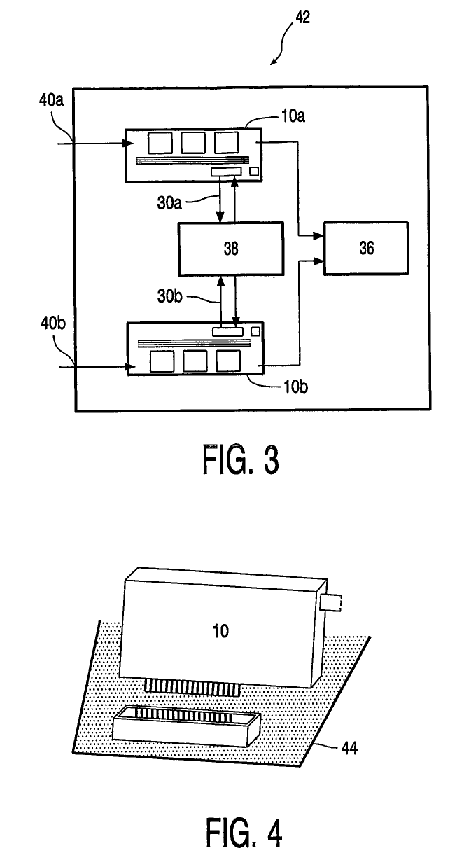

FIG. 3 shows a second embodiment of a video receiving device comprising two network interface modules.

FIG. 4 shows a perspective view of a first embodiment of a network interface module having a first type of plug-in connection.

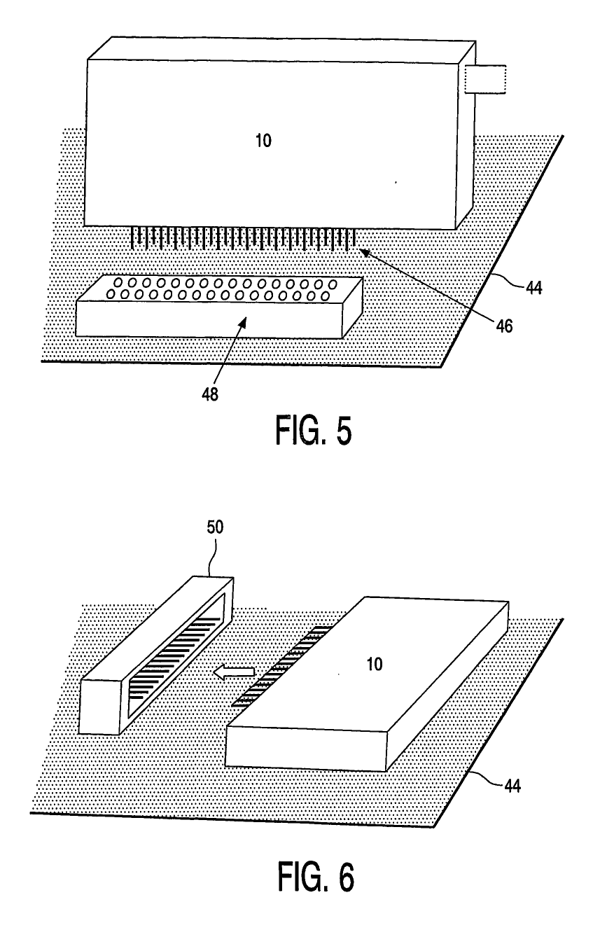

FIG. 5 shows a second embodiment of a network interface module having a second type of plug-in connection.

FIG. 6 shows a third embodiment of a network interface module having a third type of plug-in connection.

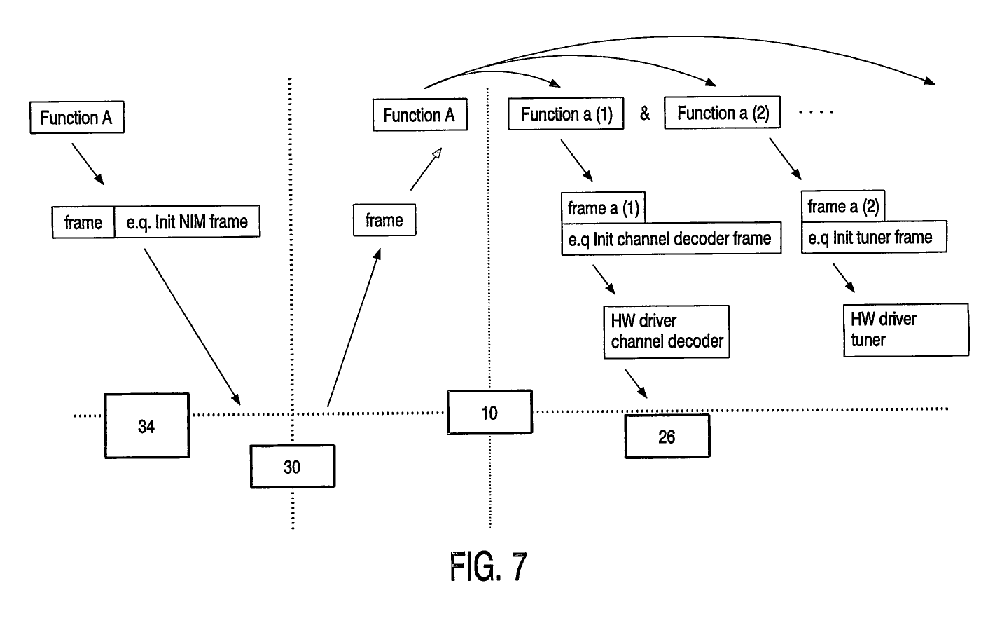

FIG. 7 shows a schematic diagram of the processing of a control command.

FIG. 1 shows a schematic diagram of a network interface module (NIM) 10 together with its functional units. The network interface module is an electrical circuit which comprises both analog electronics and digital elements. The network interface module 10 will usually be installed as a separate unit, that is to say on a dedicated board and/or within a dedicated housing. The functional units of the module 10 are—as is known to the person skilled in the art—composed of ICs that are especially suitable for this purpose.

The functional units of the module 10 comprise a tuner unit 12, an IF component 14 and a channel decoder component 16. These functional units may be designed as separate assemblies. However, it is also possible to combine in each case a number of functional units in various constellations to form one component, that is to say a special IC.

The receiving unit 12 (tuner) receives an analog HF signal via an input 20. This is an HF carrier signal comprising digital television or data signals, for example a DVB-S, DVB-T or DVB-C signal. The receiving unit 12 may be designed as an integrated circuit. It may for example be a MOPLL-IC, such as the TDA 6651. In the unit 12, the HF signal is processed and an IF signal is generated.

The IF signal is processed by the IF component 14. An AFRIC, TDA 9885, may be used for example for this purpose. The output signal from the IF IC is fed to the channel decoder unit 16.

The channel decoder 16 serves to supply digital data from the signal. A TDA 10046 which supplies an MPEG-2 transport stream (TS) may be used here for example in the case of DVB-T. The digital signal supplied by the channel decoder 16 is output via an output 22.

The functional units 12, 14, 16 require control signals to operate the module 10. Thus the receiving unit 12 requires for example the information as to which carrier signal (i.e. which frequency) is to be received. The channel decoder 16 requires for example information about which channel is to be extracted. Such control functions are dependent on the respective specific design of the components.

The module 10 comprises a microprocessor 24 which together with the functional units 12, 14, 16 is coupled to a module-internal bus 26. Furthermore, a non-volatile memory 28 is provided, for example an EEPROM, flash memory or OTP. Among other things, an operating program for the module microprocessor 24 is stored in the memory 28. After each initialization of the module 10, the operating program is read from the memory 28 and run by the processor 24. The processor 24 in turn comprises working memories, broken down into program memories and data memories.

The microprocessor may be designed separately, it being possible to use a standard microprocessor. A P87LPC764 from Philips may be used for example as microprocessor. However, it is also possible for microprocessor, memory and channel decoder to be embodied in one IC. The processor 24 manages an input/output interface 30 of the module 10. Data can be forwarded to the processor 24 via the interface 30. The interface 30 may be designed for example as a serial or parallel port. It is preferably organized as a bus.

The module processor 24 operates by means of its operating program as an interpreter which receives control commands via the interface 30 and interprets them, that is to say transmits corresponding signals to the functional units 12, 14, 16 via the bus and thus executes the respective control command. The reports are also sent back via the bus 26 from the functional units to the module processor 24. The control commands transmitted via the interface 30 are superordinate, function-related commands. These commands are converted by the interpreter program into one or usually more commands that are to be transmitted to the functional units. Whereas the commands transmitted via the bus 26 to the functional units are hardware-specific (that is to say they are dependent on the respective properties e.g. of the tuner IC 12 used), the commands received via the interface 30 are hardware-independent. They do not relate to features and capabilities of the individual functional units but rather control the module 10 as a whole as a “black box”.

The module 10 may—alone or in conjunction with other modules—be installed in a device. FIG. 2 shows a symbolic diagram of a device 34 containing a module 10.

The device 34 may be, for example, a set-top box which outputs a video signal for example for display on a TV set. It may also be a special TV set in which the receiving functionality is integrated as a component. In the device 34 shown symbolically in FIG. 2, there is a functional block 36 for the further processing (MPEG decoder, output, display, etc.) of the digital video signal.

The device 34 comprises a central device control processor 38 and an HF input 40. The HF input 40 may be for example a connection to a satellite antenna (DVB-S), a terrestrial antenna (DVB-T) or a cable television network (DVB-C). The HF carrier signal is passed directly into the module 10, where it is processed as described above. As an alternative, the module 10 may also be arranged such that the HF input of the module is directly accessible from outside.

The module 10 is controlled by means of the device control processor 38 of the device 34. This is connected to the module 10 at the interface 30 of the latter. The digital video signal output by the module 10 is then further processed by the unit 36 of the device 34.

FIG. 3 shows a second embodiment of a device 42. This device likewise comprises a central control processor 38 and a unit 36, shown in general terms here, for the further processing of digital video data. By contrast with the first embodiment shown in FIG. 2, however, two network interface modules 10a, 10b are provided. Each of these is coupled to an HF input 40a, 40b. The digital video signals output by the modules 10a, 10b are further processed by the unit 36. The central device control processor 38 controls the two modules 10a, 10b via the interfaces 30a, 30b.

The two modules 10a, 10b may be provided for processing the same type of HF carrier signal. By way of example, the two modules may be DVB-S modules which in each case receive satellite input signals at the inputs 40a, 40b. The digital video signals output by the modules 10a, 10b in accordance with the respective actuation by the central device control processor 38 may be processed by the further processing unit 36 for example such that one of the video signals passes for display (directly or on a separate TV set) while the other signal is recorded for example (in a digital memory or as an analog video signal on a conventional video recorder). It is thus possible, by means of the two NIM modules 10a, 10b, to build a device 42 having the capabilities of a known dual satellite receiver.

Alternatively, it is also possible for the NIM modules 10a, 10b to be designed for different types of HF carrier signal. Thus, for example, the module 10a may be designed for satellite reception (DVB-S) while the module 10b is designed for terrestrial radio reception (DVB-T). The device 42 may then process signals from both sources, with the control processor 38 selecting whether the currently processed video signal is supplied by the module 10a or by the module 10b.

Finally, a device (not shown) may also comprise more than two modules. These may all be of different types or else a number of modules for the same type of HF carrier signal may be provided.

The NIM modules 10 may be coupled into or onto the respective device 34, 42 in various ways. A plug-in connection is preferred. Examples of such plug-in connections are shown in FIGS. 4 to 6, in which in each case an NIM module 10 is attached to a motherboard 44 of the respective device and mechanically coupled there.

The module 10 in FIG. 4 comprises a pin connector which is received in a corresponding socket of the board 44 perpendicular to the latter. FIG. 5 shows a further embodiment in which a pin connector 46 of the module 10 is received in a corresponding socket 48 of the board 44 perpendicular to the latter. Finally, FIG. 6 again shows a module 10 having a board connector, which is received in a socket 50 with the plug-in direction parallel to the board 44.

The respective modules 10 in FIGS. 4, 5 and 6 are in each case a board which comprises elements as shown in FIG. 1 and is arranged in a housing. The various inputs and outputs 20, 22, 30 shown in FIG. 1 and also additional inputs (e.g. power supply) are realized via the respective plug-in contacts.

In this case, the pin assignment is defined and is identical for different modules. By way of example, it may be defined that a DVB-S input signal is always present at pin 3 of the plug-in connection, a DVB-T input signal is always present at pin 5 of the plug-in connection and a DVB-C input signal is always present at pin 7, while the output video signals are always output at the same pins of the plug-in connection.

With such a common pin assignment, in conjunction with the control of the NIM modules 10 via control commands (interface 30), the respective device 34, 42 does not require any information about the specific hardware of the module 10 used. Actuation takes place by means of purely function-based, hardware-independent control commands. The resulting digital video, audio and data signal is present at the defined contacts.

The NIM modules 10 shown in FIGS. 4 to 6 can be easily replaced on account of their plug-in contacts. When replacing a module 10, it may be provided that firstly a number of configuration commands are exchanged between the module microprocessor 24 and the control processor 38 via the interface 30. During the self-configuration, the NIM processor 24 informs the device control processor 38 about the type of module used (e.g. DVB-T, DVB-S, DVB-C) and the following information for example: address of the NIM microprocessor, details about the transponder and/or satellite and frequency ranges in the case of DVB-S, details about the frequency ranges and whether OFDM or 8-VSB reception is to be set in the case of DVB-T, and the frequency range and the encoding in the case of DVB-C.

On the other hand, during the automatic configuration the NIM may also receive information, such as the address of the device microcontroller for example.

Hereinbelow, the interpretation by the module microprocessor 24 of hardware-independent control commands transmitted via the interface 30 and the conversion thereof into hardware-dependent commands at the functional units 12, 14, 16 will be explained with reference to FIG. 7.

As already mentioned, the commands transmitted from the control microprocessor 38 of the device to the module microprocessor 24 are hardware-independent. They relate to functions of the NIM without the design of the NIM being known in detail.

The processing of a control command is shown in general and with reference to an example in FIG. 7. Here, the interaction of the various components of the device 34 from FIG. 2 is shown on the one hand on the hardware side (below the dashed horizontal line) and on the other hand on the software side (above the horizontal dashed line). The vertical dashed lines separate the regions of the device 34 (on the left in FIG. 7), communication between device control processor 38 and NIM 10 (in the center in FIG. 7) and within the NIM 10 (on the right in FIG. 7).

It is shown how a command “Function A” is transmitted from the control processor 38 of the device 34 via the interface 30 (organized in the form of a bus for example) to the module 10. In the example shown, the command is “Init NIM frame”. The correspondingly encoded command is recognized by the microprocessor 24 of the module 10, said microprocessor operating as interpreter. The operating program of the module microprocessor 24 contains—for example in the form of a look-up table—information as to how the received command is executed, that is to say how the superordinate “Function A” is converted into part-functions “Function a (1)”, “Function a (2)”, etc. These part-functions are transmitted to the respective functional units 12, 14, 16, 18 via the module-internal bus 26 as Frame a (1), Frame a (2).

By way of example, the command “Init NIM frame” is converted into the command “Init channel decoder frame”, which is transmitted to the channel decoder component 16, and the command “Init tuner frame”, which is transmitted to the receiving functional unit 12. These are IC-specific commands, that is to say the channel decoder 16 is addressed directly.

Further examples of control commands are given below, in each case with the actuations of the functional units that are necessary in the conversion:

Set Frequency: setting of frequency range/PLL data/AFC function

Actuation of channel decoder: registers are used for this operating mode; checking as to whether a digital channel is present here; checking as to whether an analog channel is present here.

Actuation of tuner IC (MOPLL): PLL is set for this frequency

possibly actuation of IF IC: setting of the intermediate frequency parameters (standard/sound traps/etc.).

Search: start search routine

Actuation of tuner (MOPLL): PLL values are continuously increased

Actuation of channel decoder: checking of input signals/inquiry as to receiving parameters/read BER (Bit Error Rate), forward to device.

Co-channel receiving mode: call up specific receiving settings

Actuation of channel decoder: change various parameters and search for BER optimum, forward data to device.

1. A network interface module for receiving video data, comprising
functional units (12, 14, 16) for processing a high frequency signal and for supplying a digital video signal, and
also at least one module microprocessor (24),
a memory (28) for an operating program of the module microprocessor (24), and
an interface (30) for the inputting of control commands, where the module microprocessor (24) processes the control commands during running of the operating program and actuates the functional units (12, 14, 16) accordingly.

2. A module as claimed in claim 1, wherein the control commands control functions of the module (10), with the control commands being independent of the type of functional units (12, 14, 16) present.

3. A module as claimed in claim 1, wherein the functional units comprise at least one receiving functional unit (12) and one channel decoder functional unit (16).

4. A device for receiving video data, comprising
at least one control processor (38), and
at least one network interface module (10) as claimed in claim 1,
where the control processor (38) forwards control commands to the network interface module (10) via the interface (30).

5. A device as claimed in claim 4, wherein the module (10) is replaceable, and is preferably connected to the device (34, 42) by way of a plug-in connection.

6. A device as claimed in claim 4, wherein a number of modules (10a, 10b) are present.

7. A device as claimed in claim 6, wherein at least two modules (10a, 10b) for receiving the same type of high frequency signal are provided, and/or modules (10a, 10b) for receiving at least two different types of high frequency signal are present.

8. A device as claimed in claim 4, wherein a number of slots for the plugging-in of modules (10) are provided, where the slots have the same assignment.

9. A method of receiving video data, wherein a control processor (38) of a receiving device uses control commands to control a network interface module (10) comprising functional units (12, 14, 16) for processing a high frequency signal and supplying a digital video signal, where in the network interface module (10) a module processor (24) processes the control commands and actuates the functional units (12, 14, 16) of the network interface module (10) accordingly.
